(19) United States
(12) Patent Application Publication
(10) Pub. No.: US 2026/0073698 A1
(43) Pub. Date: Mar. 12, 2026

(54) SYSTEMS AND METHODS FOR MONITORING OPERATION OF A SOLID FUEL BURNING DEVICE

(71) Applicant: MF FIRE, INC., Baltimore, MD (US)

(72) Inventors: Paul LaPorte, Pikesville, MD (US); Ryan Fisher, New Market, MD (US)

(21) Appl. No.: 19/326,832

(22) Filed: Sep. 12, 2025

Related U.S. Application Data
(60) Provisional application No. 63/693,756, filed on Sep. 12, 2024.

(51) Int. Cl. G06V 20/52; F24B 13/00; H04N 7/18

(52) U.S. Cl. CPC G06V 20/52; F24B 13/00; H04N 7/183

(57) ABSTRACT

Operation of a solid fuel burning device can be monitored using a video sensor located remote from the solid fuel burning device and at least another sensor. The video sensor can record video data that monitors actions and behavior related to the solid fuel burning device. The other can record at least temperature data related to the solid fuel burning device. A controller can: detect an occurrence related to an object in at least the video data; create an identified occurrence; determine a context of the identified occurrence based on a stage of a fire cycle of the solid fuel burning device; and characterize the identified occurrence in the context as satisfactory or sub-optimal, such that: when the identified occurrence in the context is satisfactory, continue normal operation; and when the identified occurrence in the context is sub-optimal, send a message to a user of the solid fuel burning device.

### RELATED APPLICATIONS

This application claims priority to U.S. Provisional Application Ser. No. 63/693,756, filed Sep. 12, 2024, entitled “STATE CHANGE DETECTION SYSTEM AND METHOD FOR DETERMINING SOLID FUEL HEATER OPERATIONAL STATE”. The entirety of this provisional application is hereby incorporated by reference for all purposes.

### TECHNICAL FIELD

This disclosure relates generally to monitoring operation of a solid fuel-burning device, and more specifically to systems and methods that can monitor operation of the solid fuel burning device using at least one sensor that is separated from the solid fuel burning device by an air-gap.

### BACKGROUND

Millions of homes in the United States, and up to half a billion homes worldwide, are equipped with a solid fuel burning device (e.g., wood stoves, pellet stoves, fireplaces, and/or other devices that burn solid and/or semi-solid fuel). Most of these solid fuel burning devices are manually operated according to basic instructions for general safe use, not for most effective use, by users with an incomplete understanding of best practices for using the solid fuel burning device. At a given time most users know very little about specific operating states, variables, and best operating procedures for desired results (e.g., best heat output, efficiency, fuel conservation, etc.). At least due to this lack of knowledge, it is difficult, or even impossible, to operate the solid fuel burning device near an optimal state a desired result. Accordingly, standard user operation can result in high emissions, low efficiency, fuel waste, and more. While specific sensors such as temperature sensors, smoke detectors, and the like can be utilized to provide some information about usage, solid fuel burning devices offer an inhospitable environment for sensors (e.g., high temperatures, temperature swings, harsh smokes, etc.) that can cause error in measurements, constant replacement, and/or false alarms. Moreover, such individual sensors are insufficient to provide guidance for users to improve their effective use of their specific solid fuel burning devices for their desired results.

### SUMMARY

Described herein are systems and methods that can monitor operation of a solid fuel burning device using at least one sensor that is separated from the solid fuel burning device by an air-gap (e.g., a video sensor, an audio sensor, a temperature sensor, or the like) and at least one other sensor that can be separated from the solid fuel burning device and/or local to the solid fuel burning device (e.g., a temperature sensor, a chemical sensor, or the like). The use of at least one remote sensor that is air-gapped from the solid fuel burning device can enable knowledge of specific operating states and/or variables of the solid fuel burning device, without violating EPA regulations.

In an aspect, the present disclosure can include a system that can monitor operation of a solid fuel burning device. The system can include at least one video sensor, at least one other sensor, and at least one controller. The at least one video sensor can be located remote from the solid fuel burning device and can be configured to record video data that monitors actions and behavior related to the solid fuel burning device. The at least another sensor can be configured to record at least temperature data related to the solid fuel burning device. The at least one controller can include a non-transitory memory storing instructions and a processor to execute the instructions. The instructions can include: receive the video data and the other temperature data, and based on the video data at a time and the other temperature data at the time: detect an occurrence related to an object associated with the solid fuel burning device in at least the video data; create an identified occurrence by selecting an identifier for the occurrence based on the video data and/or the other temperature data; determine a context of the identified occurrence based on at least a stage of a fire cycle of the solid fuel burning device; and characterize the identified occurrence in the context as satisfactory or sub-optimal, such that: when the identified occurrence in the context is satisfactory, continue normal operation; and when the identified occurrence in the context is sub-optimal, send a message to a user of the solid fuel burning device (e.g., a warning, instructions to fix usage, suggestions for next time a similar context occurs, etc.).

In another aspect, the present disclosure can include a method for monitoring operation of a solid fuel burning device with a system comprising a processor. Video data related to the solid fuel burning device can be received from a sensor located remotely from the solid fuel burning device and another data type comprising at least temperature data related to the solid fuel burning device can be received from at least another sensor. An occurrence related to an object associated with the solid fuel burning device can be detected in at least the video data. An identified occurrence can be created by selecting an identifier for the occurrence based on the video data and/or the temperature data and/or other data. A context of the identified occurrence can be determined based on at least a stage of a fire cycle of the solid fuel burning device. And the identified occurrence in the context can be characterized as satisfactory or sub-optimal. When the identified occurrence in the context is characterized as satisfactory, the user and/or the solid fuel burning device can continue normal operation. When the identified occurrence in the context is characterized as sub-optimal, then a message can be sent to the user of the solid fuel burning device (e.g., a warning, instructions to fix usage, suggestions for next time a similar context occurs, etc.).

### BRIEF DESCRIPTION OF THE DRAWINGS

The foregoing and other features of the present disclosure will become apparent to those skilled in the art to which the present disclosure relates upon reading the following description with reference to the accompanying drawings, in which:

FIG. 1 is a block diagram of a system that can monitor operation of a solid fuel burning device using at least one sensor that is separated from the solid fuel burning device by an air gap;

FIG. 2 is a block diagram of an example of the system of FIG. 1;

FIGS. 3 and 4 are block diagrams showing example placements of sensors of the system of FIG. 1;

FIG. 5 is a block diagram of the controller of FIG. 1

FIG. 6 is a process flow diagram of a method of improved operation of a solid fuel burning device according to the system of FIG. 1;

FIG. 7 is a process flow diagram of a method for monitoring operation of the solid fuel burning device for improved effectiveness and/or efficiency;

FIG. 8 is a process flow diagram of a method for characterizing an occurrence related to an object of the solid fuel burning device as satisfactory or sub-optimal; and

FIG. 9 is a process flow diagram of a method for selecting an identifier of an occurrence related to an object of the solid fuel burning device.

### DETAILED DESCRIPTION

### I. Definitions

Unless otherwise defined, all technical terms used herein have the same meaning as commonly understood by one of ordinary skill in the art to which the present disclosure pertains.

As used herein, the singular forms “a,” “an,” and “the” can also include the plural forms, unless the context clearly indicates otherwise.

As used herein, the terms “comprises” and/or “comprising,” can specify the presence of stated features, steps, operations, elements, and/or components, but do not preclude the presence or addition of one or more other features, steps, operations, elements, components, and/or groups.

As used herein, the term “and/or” can include any and all combinations of one or more of the associated listed items.

As used herein, the terms “first,” “second,” etc. should not limit the elements being described by these terms. These terms are only used to distinguish one element from another. Thus, a “first” element discussed below could also be termed a “second” element without departing from the teachings of the present disclosure. The sequence of operations (or acts/steps) is not limited to the order presented in the claims or figures unless specifically indicated otherwise.

It will be understood that when an element is referred to as being “on,” “attached” to, “connected” to, “coupled” with, “contacting,” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

As used herein, the term “solid fuel burning device” can refer to any device that combusts solid fuel (any natural and/or manufactured solid material that is burned to produce energy; e.g., wood, charcoal, peat, coal, hexamine fuel tablets, wood pellets, grains, etc.). Solid fuel burning devices can include, but are not limited to, wood stoves, other solid fuel burning stoves, fireplaces, fireplaces inserts, combination fuel furnaces or boilers used for space heating which can burn solid fuel, solid fuel burning cooking stoves, or the like.

As used herein, the terms “user”, “operator”, and the like, can be used interchangeably to refer to an individual who operates a solid fuel burning device and/or the system described herein. For example, operating the solid fuel burning device can include preparing for, assisting, and/or operating the solid fuel burning device. Operating the system described herein can include setting up the sensors, calibrating the system, interacting with the controller, responding to prompts from the controller, or the like.

As used herein, the term “object associated with a solid fuel burning device” can refer to a user that interacts with a solid fuel burning device, a part of the solid fuel burning device, an element put into the solid fuel burning device, an element input into the solid fuel burning device (e.g., placed in the firebox), and element formed and/or output by the solid fuel burning device. For example, a component of the solid fuel burning device can include a door, a fire box, a valve, a door latch, a pilot light, a chimney flue, a damper, and the like. As another example, an element input into the solid fuel burning device can include the solid fuel, a coolant, a starter material, an accelerant, and the like. As a further example, an element output by the solid fuel burning device can include flame, smoke, and the like. At least some of the objects associated with the solid fuel burning device can be pre-loaded in the system memory and/or can be entered into the system memory during a calibration stage.

As used herein, the term “sensor” can refer to a device that detects or measures a physical property as data and records the data. The sensor can send the data to a device containing a processor for further processing. The sensor can be, but is not limited to, a temperature sensor, such as a thermocouple, an image sensor, such as a camera or light detector, an audio sensor, such as a microphone, a video sensor, an image sensor, a mechanical sensor, such as a pressure sensor or proximity sensor, or any other type of sensor. A sensor can detect, for example, visual, audio, light, temperature, pressure, proximity to two components, chemical compounds or particulates (e.g., oxygen, carbon monoxide, carbon dioxide, PM2.5 particles, etc.), or the like. A sensor can be local to the solid fuel burning device or remote from the solid fuel burning device (e.g., separated by an air gap). A sensor that is local to the solid fuel burning device can be placed inside a solid fuel burning device (e.g., in the primary fire box, on the catalyst, inside the chimney/exhaust pipe, on the inside of the door, etc.) and/or on the outside of a solid fuel burning device (e.g., on the outside of the door, on the outside of the firebox, on the outside of the chimney/exhaust pipe, etc.

As used herein, the terms “air-gap” and “air gap” can refer a physical separation between elements of a system. For example, a sensor can be separated from a solid fuel burning device by an air-gap so that the sensor is remote from the solid fuel burning device. In other words, when separated by an air-gap, the sensor is not directly attached to, in contact with, and/or inside a component of the solid fuel burning device. Examples of sensors that can be separated from the solid fuel burning device by the air-gap can include, but are not limited to, video cameras, external temperature sensors, microphones, controllers, and the like.

As used herein, the term “occurrence” can refer to an interaction or action related to the solid fuel burning device, such as an action by a user on at least one object related to the solid fuel burning device, a change in a state of at least one object related to the solid fuel burning device, or the like. An occurrence can include, for non-limiting example, a door being at least partially opened or closed, a damper being opened or closed, an amount of a type of solid fuel being added, a change in temperature of the fire, a change in a temperature of a component of the solid fuel burning device, a change in smoke output and/or composition, or the like.

As used herein, the term “identifier” can refer to a pre-determined state of the solid fuel burning device and/or objects associated with the solid fuel burning device. There can be multiple possible identifiers each associated with a different pre-determined state of the solid fuel burning device and/or the objects associated with the solid fuel burning device. For example, a door can have an identifier of open, closed, or partially open. A solid fuel can have identifiers such as: the category (e.g., wood, coal, pellets, etc.), the type (e.g., for wood—pine, oak, maple, birch, cedar, etc.), state (e.g., wet, damp, dry, old, etc.), and/or amount (e.g., number of pieces, comparative amounts (small, medium, large), etc.). It should be understood that these are only examples and other identifiers can exist to classify other states associated with the solid fuel burning device and/or objects associated with the solid fuel burning device.

As used herein, the term “context” can refer to one or more circumstances that form a setting for the occurrence related to and/or associated with the solid fuel burning device and/or object(s) associated with the solid fuel burning device. For example, context can include the user's desired result (e.g., higher temperatures, efficient use, lower fuel consumption, etc.), a stage of a fire cycle, or the like.

As used herein, the term “fire cycle” can refer to the life cycle of a fire and can be described in distinct stages of fire development, including, but not limited to, the Incipient (Ignition) Stage, the Growth Stage, the Fully Developed (Flashover) Stage, and the Decay Stage. It should be understood that stages can be known by other names as are known in the field and that this listing includes major stages and is not intended to be limiting. Understanding the phases of a fire cycle is crucial for assessing fire behavior, predicting risks, and implementing safety measures. The stage of a fire cycle can be an important part of the context that can be used to determine if an occurrence is satisfactory or not at a given time.

### II. Overview

Solid fuel burning devices are the primary or secondary heat sources for many homes around the world. The vast majority of solid fuel burning devices are manually operated by a user. Unfortunately, the user often has limited knowledge about the solid fuel burning device (e.g., components, use, attributes, states, or the like of the solid fuel burning device and/or related fire cycle states), making it difficult to operate the solid fuel burning device effectively and efficiently. This limited knowledge can lead to, for example. high emissions, lower efficiency, fuel waste, extreme temperature fluctuations, improper cleaning and/or maintenance, dangerous conditions, and the like. Sensors in and/or attached to the solid fuel burning device can help the user understand how their solid fuel burning device reacts to given actions. However, regulations (e.g., EPA, international, etc.) severely limit modification or retrofitting of solid fuel burning devices that are already certified or installed (which accounts for the vast majority of solid fuel burning devices).

Described herein is a system that can be used within these regulations. The system can include at least one sensor that is remote from a solid fuel burning device and separated by an air gap (also referred to as air-gapped sensors). Notably, the system can both monitor the solid fuel burning device across the air gap and provide guidance to achieve optimal operation of the solid fuel burning device. The air-gap allows the at least one sensor (and additional components, such as power elements, controllers, etc.) to be positioned in the vicinity of the solid fuel burning device, without being directly attached to, inside, and/or in contact with any part of the solid fuel burning device. Additionally, the system can take data from the one or more air-gapped sensors, which may not be traditional operational data, and determine optimal device management techniques for each unique situation encountered. For instance, the system can detect operational actions of the user, fuel consumption data, discern intent and classification of actions, and provide instructions and/or alerts to users to improve their actions.

### III. Systems

Solid fuel burning devices often are operated by users informed with only basic use and safety instructions and often lacking high accuracy, quantitative data during use (e.g., at a given moment of time), which can lead to ineffective and/or inefficient use, and in some cases dangerous and even deadly situations (e.g., excess flames, creosote buildup, etc.). Regulations make it nearly impossible to modify and/or retrofit certified or already installed solid fuel burning devices with sensors that could help users learn more about their solid fuel burning devices. The system described herein bypasses such regulations by utilizing air-gapped sensors in combination with novel software to monitor a solid fuel burning device and instruct a user on improved use of their solid fuel burning device (e.g., safer use, more proper and/or accurate usage, better efficiency, lower emissions, or the like).

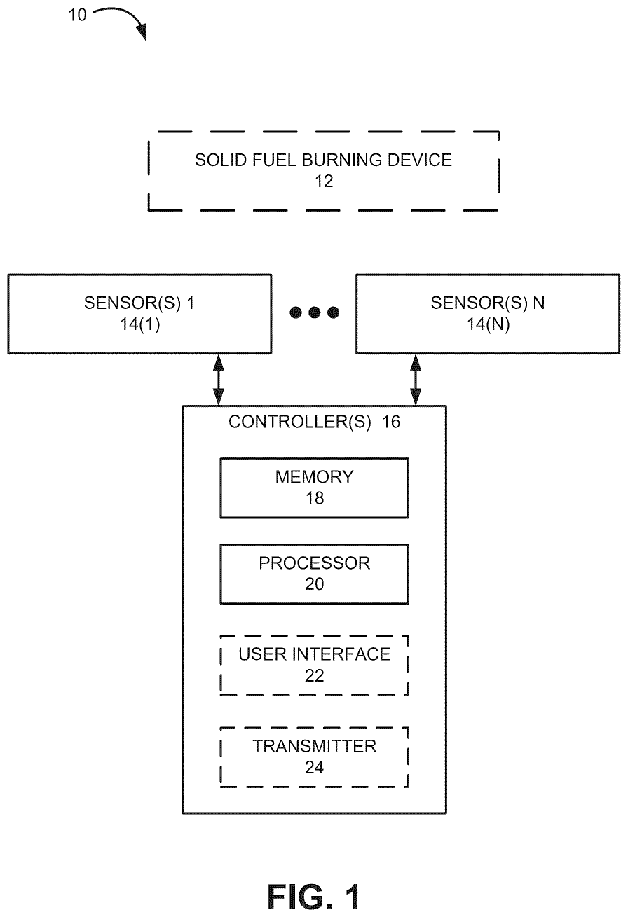

It should be understood that instructions for using solid fuel burning devices are not one size fits all. Each solid fuel burning device can have different variables (e.g., location in home, size, age, etc.) and optimal usage conditions for different desired results from use to use (e.g., lower emissions, higher fuel efficiency, specific desired room temperature, or the like). Moreover, each interaction (e.g., by the user or environmental factors) with the solid fuel burning device can alter what instruction can lead to optimal operation (e.g., user inputs wet wood instead of dry, too much or too little fuel is added, fuel is added too soon or too late, or the like). Accordingly, a system for providing instructions for optimal operation of a solid fuel burning device needs to be able to monitor the solid fuel burning device in real time and then quickly make determinations of instructions based on that monitoring. FIG. 1 illustrates a system 10 that can monitor operation of a solid fuel burning device using at least one sensor 14(1) that is separated from the solid fuel burning device 12 by an air gap.

The system 10 can monitor a solid fuel burning device 12 and at least a portion of the surroundings of the solid fuel burning device to provide improvements for effective and/or efficient use of the solid fuel burning device. The system 10 can include at least two sensors (e.g., at least one sensor 14(1) (e.g., sensor(s) 1) and at least one other sensor 14(N) (e.g., sensor(s) N)) that can each detect and/or record data regarding operation of the solid fuel burning device 12. The system 10 can also include at least one controller 16 that can be in communication with the at least two sensor(s).

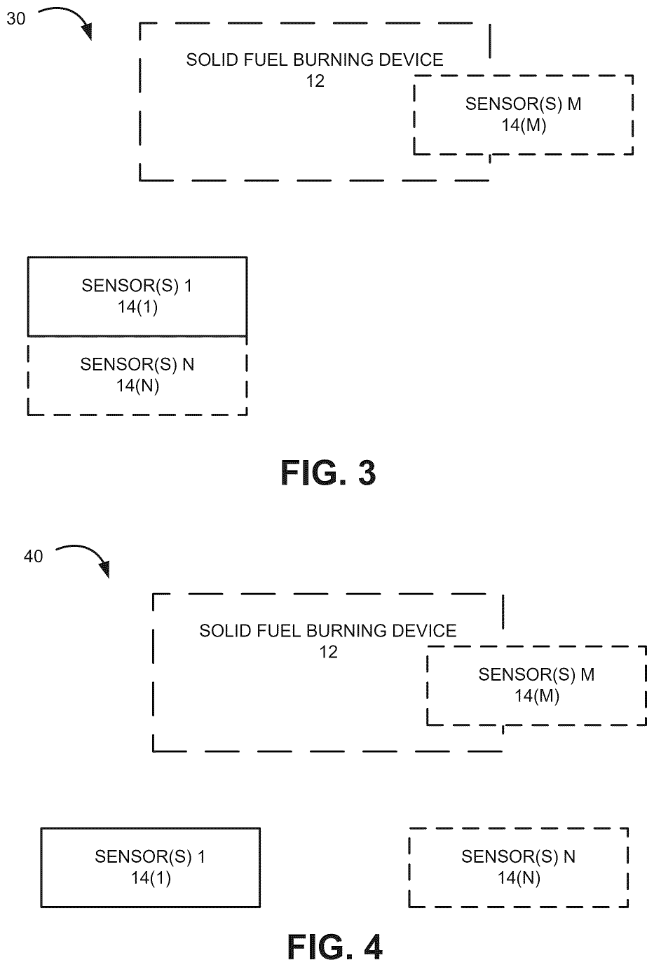

One of the sensors (e.g., sensor(s) 14(1)) can be located remote (e.g., air-gapped) from the solid fuel burning device 12. The sensor(s) 14(1) can record data that monitors at least actions and behaviors (e.g., occurrences) related to the solid fuel burning device 12. Another of the sensor(s) 14(N) can be at least one other sensor (the same type or different) that can record at least another data stream (same or different type) related to the solid fuel burning device 12 and/or actions/behaviors related to the solid fuel burning device. The sensor(s) 14(N) can be remote (air-gapped) from the solid fuel burning device 12 and/or can be positioned locally to the solid fuel burning device and/or can be part of the solid fuel burning device. Specific sensor 14(1)-14(N) positioning relate to the solid fuel burning device is described in more detail with respect to FIGS. 3 and 4. The sensor(s) 14(1)-14(N) can be for example, video sensor(s) (e.g., digital imaging sensors, or the like), light sensor(s) (e.g., photodiodes or the like), temperature sensor(s) (e.g., thermal imaging sensors or the like), audio sensor(s) (e.g., microphones or the like), pressure sensor(s), smoke detector(s), chemical sensor(s), or the like. For instance, sensor(s) 14(1) can be one or more video sensors and other sensor(s) 14(N) can be a type of other sensor, such as temperature sensor(s). In another instance, sensor(s) 14(1) can be one or more video sensors and sensor(s) N can be two or more types of other sensors—one or more temperature sensors and one or more other sensors (e.g., audio, light, pressure, smoke, chemical, or the like), or any combination thereof.

Each of the sensor(s) 14(1)-14(N) (or 14(M) as discussed below in FIGS. 3 and 4) can be in communication with at least one controller 16 (e.g., a standalone hub, a smart phone, a smart TV, tablet, a computer, or the like) that can perform at least a portion of the monitoring and output instructions for more optimal operation of the solid fuel burning device 12 and/or alterations for the solid fuel burning device. The communication can be wired and/or wireless. The controller(s) 16 can include at least a non-transitory memory 18 that can store instructions and a processor 20 that can execute the instructions. The memory 18 can, in some instances, additionally store recorded data, processed data, operational information about the solid fuel burning device, user preferences, identified occurrences in context and their outcomes, and/or the like. The memory 18 and the processor 20 can be embodied as separate devices or the same device. Examples of the at least one non-transitory memory 18 can include volatile memory (e.g., RAM), nonvolatile memory (e.g., a hard disk, a flash memory, a solid state drive, or the like), or a combination of both volatile and non-volatile memory. The at least one processor 20 can include one or more processing cores, for example, which can access the non-transitory memory 18 and can optionally implement functionality of a cloud-based server (not shown). In some instances, functionality associated with the memory 18 and the processor 20 can be embedded in the same device, like a microprocessor. In some instances, the instructions can be stored and/or executed at least partially on a first controller (having a first memory and/or processor, such as a standalone hub) and at least partially on at least one other controller (having at least one other memory and/or processor, such as a smartphone).

The controller(s) 16 can, in some instances, include a user interface 22 (or be in communication with an external device with a user interface). The user interface 22 can include an input device (e.g., microphone, keyboard, touch screen, buttons, etc.), visual display (e.g., a screen, projection, light(s), or the like), an audio output (e.g., a speaker), and/or a haptic device (e.g., motor or the like). The user interface 22 can output information and messages to the user and can allow the user to input information into the system 10. The controller(s) 16 can also include a wireless transmitter 24, which can allow communication between at least two of: the at least one memory 18, the at least one processor 20, the sensor(s) 14(1) and at least one other sensor(s) 14(N), the cloud server (not shown), the user interface 22, and/or another controller (e.g., between a standalone hub and a smartphone or smart TV). The wireless transmitter can communicate according to one or more protocols, including Bluetooth, cellular, WiFi, or the like.

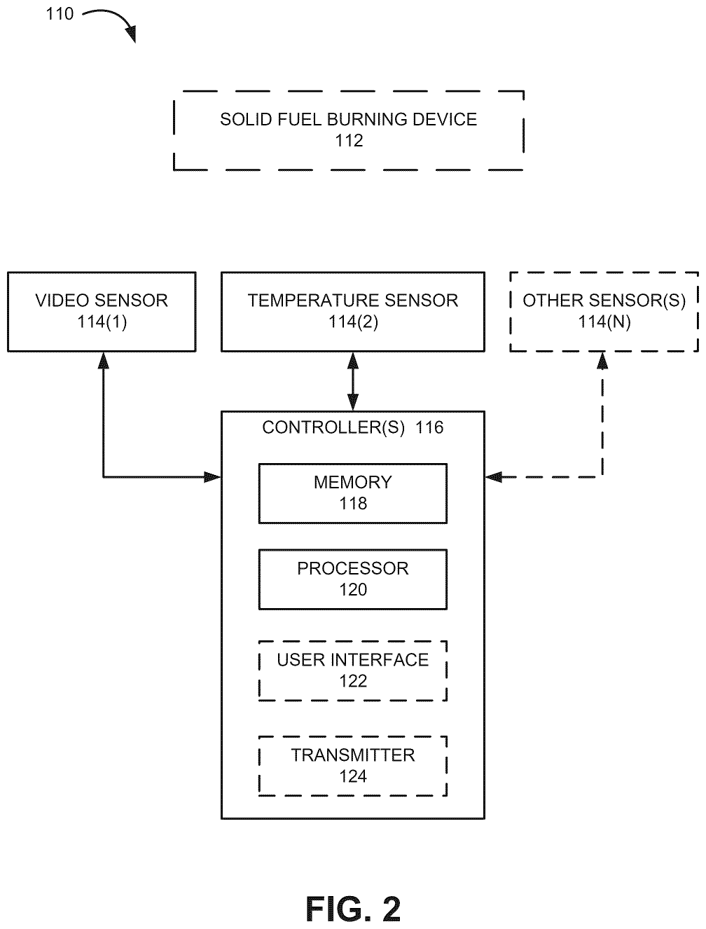

FIG. 2 shows an example system 100 (an example of system 10) that monitors operation of a solid fuel burning device 112, which can include at least one video sensor 114(1) (remote from the solid fuel burning device) and at least one temperature sensor 114(2) (remote and/or local to the solid fuel burning device, illustrated as remote). Other types of sensors 114(N) (which may be local and/or remote) can optionally also be included in system 100 as discussed above. The video sensor(s) 114(1) can be located remote (e.g., air-gapped) from the solid fuel burning device 112 and can record video data of the solid fuel burning device that can encompass at least a portion of the solid fuel burning device and/or at least a portion of the area near the solid fuel burning device. The video sensor(s) 114(1) can monitor actions and behaviors related to the solid fuel burning device 112. For example, the video sensor(s) 114(1) can detect and capture visual state information about components of the solid fuel burning device, including, but not limited to the state of the door (e.g., open, closed, a % opened or closed, or the like), the bypass (e.g., open, closed, a % opened or closed, or the like), the air control (e.g., position 1-N determined based on the given type of air control), or the like. The temperature sensor(s) 114(2) can record at least temperature data (e.g., operating temperature) related to at least a portion of the solid fuel burning device 112 (e.g., the temperature radiating from the device, the temperature of the door, the temperature of the chimney pipe, etc.). The temperature sensor(s) 114(2) can be, for example, thermal imaging sensor(s) (such as infrared temperature sensors), thermocouple, resistance temperature detectors, thermistors, semiconductor based (IC) sensors, or the like depending on location (e.g., local to or remote from the solid fuel burning device). Temperature sensor(s) 114(2) can be directed to towards (or put near/on) one or more portions of the exterior and/or interior of the solid fuel burning device 112 (e.g., door, top, bottom, or side of fire box, flue, etc.) and the controller (e.g., 116) can account for how different materials (e.g., steel, brick, glass, etc.) conduct heat. The controller 116 of example system 100 can monitor the solid fuel burning device through the video sensor(s) 114(1) and the temperature sensor(s) 114(2), and, optionally, the optional other sensor(s) 114(N) and send instructions/alterations as discussed in detail for system 10. As an example, the optional other sensor(s) 114(N) can include a light capture sensor, a temperature sensor, an audio sensor, a pressure sensor, a chemical sensor, or the like.

In some instances, the controller 116 can include a digital image processor and a computer vision engine (e.g., stored in memory 118 and executed by processor 120). The digital image processor can pre-process raw data (e.g., digital images) received from the video sensor(s) 114(1) for use by the computer vision engine. Non-limiting examples of pre-processing (for at least video data) can include adjusting for varying ambient light, removal of artifacts or moving objects (e.g., animals, children, non-operators, etc.) that transit in front of the solid fuel burning device in a time sequenced set of images or scans, conversion of file formats (e.g., JPEG, PNG, TIFF, MPEG, MP4, AVI, etc.) to a math matrix representing a series of key vectors describing an occurrence related to an object associated with the solid fuel burning device 112). The computer vision engine can transform the pre-processed data into a secondary set of state information and meta data (e.g., identifiers linked to at least one of the object(s), the occurrence(s), etc.) and then analyze the resulting data to determine key actionable information (e.g., instructions based on the identifier(s). An example set of analysis steps may include: identification of a target component of the solid fuel burning device 112 (or other object associated with the solid fuel burning device) such as a door object, calculate the new 3D position and location of the door compared to the last known position, infer (based on at least training data) if the door identifies as open, closed, or partially open/closed, and if the door position identifies as open and this is a new, changed value or has been noticed for an amount of time greater than a pre-set limit, then consult the rules engine to determine what action should be taken/provided (e.g., based on context—e.g., should the door be open). The rules engine can provide instructions for responses to identified occurrences in context, warnings, suggestions, alterations of the solid fuel burning device, or the like to be output by the controller 116. The controller 116 can also include a communications module (e.g., transmitter 124) to transmit the post-processed image data to a remote computer vision engine (e.g., a remote server, a cloud server or the like), to a user interface 122 not embodied with and/or in wired communication with the controller, or the like.

FIGS. 3 and 4 shows example set ups (30 and 40) of positionings of sensor(s) of system 10 relative to a solid fuel burning device. When the sensor(s) are described as remote or, in other words, air-gapped from the solid fuel burning device the sensors do not touch any portion of the solid fuel burning device. Remote/air-gapped sensors can be positioned generally in the room (e.g., on furniture, walls, etc.), on non-regulated structural features built around the solid fuel burning device (e.g., the mantel, hearth, chimney, etc.). Local sensors can be placed inside a solid fuel burning device (e.g., in the primary fire box, on the catalyst, inside the flue/exhaust pipe, on the inside of the door, etc.) and/or on the outside of a solid fuel burning device (e.g., on the outside of the door, on the outside of the firebox, on the outside of the chimney/exhaust pipe, etc.).

FIG. 3 shows example setup 30 with the sensor(s) 14(1) and the at least the other sensor(s) 14(N) (which can be one or more other types of sensors that are the same as or different from the first sensors) can be positioned at a same remote location air-gapped from the solid fuel burning device 12. It should be understood that N can be any number two or greater such that a plurality of sensors two or more can be positioned remote from the solid fuel burning device 12 although additional sensors are not illustrated for ease of illustration only. For example, the sensor(s) 14(1)-14(N) can share a housing (e.g., a video camera with a microphone, a video camera with an infrared sensor for sensing temperature, or the like). Optionally, another type of sensor 14(M) can be positioned locally to the solid fuel burning device 12 (e.g., in, on, in contact with, integral with, or the like the solid fuel burning device). In some instances, only sensor(s) 14(1) and sensor(s) 14(N) may be part of the set up. In other instances, only sensors 14(1) and sensor(s) 14(M) may be part of the set up. In further instances, sensor(s) 14(1), sensor(s) 14(N), and sensor(s) 14(M) may be part of the set up. For example set up 30, when sensor(s) 14(1)-14(N) are two or more of each sensor are used then the sensors can be positioned in groups (e.g., one group of sensors 14(1)-14(N) at a first location and another group of sensors 14(1)-14(N) at another location, and the like). For example, sensor(s) 14(1)-14(N) can be positioned on a wall, mantel, bookshelf, coffee table, or the like and pointed at least partially at the solid fuel burning device 12. This approach to air-gapped monitoring can avoid significant issues with sensor(s) in close proximity to solid fuel burning devices (e.g., regulations, constant replacement of batteries and/or sensor(s), safer adjustment and/or installation, or the like). Sensor(s) 14(1)-14(N) (in FIGS. 3 and 4) may be standalone and/or integrated with one or more controllers (not shown for ease of illustration)

FIG. 4 shows example setup 40 with the sensor(s) 14(1) and the at least the other sensor(s) 14(N) (which can be one or more other types of sensors than the first sensors—different from or the same as) can be positioned at different remote locations, both air-gapped from the solid fuel burning device 12. For example, sensor(s) 14(1) can be one or more video cameras positioned in a room to view at least part of the solid fuel burning device 12 and other sensor(s) 14(N) can be a temperature sensor positioned at another location in the room to sense temperature from at least part of the solid fuel burning device. In another example, the other sensor(s) 14(N) can include a smoke detector positioned on a ceiling of the room, a microphone positioned in a portion of the controller (e.g., a hub, a tv, a smart phone, etc.). It should be understood that N can be any number two or greater such that a plurality of sensors two or more can be part of example setup 40, although additional sensors are not illustrated for ease of illustration only. Optionally, another type of sensor 14(M) can be positioned locally to the solid fuel burning device 12 (e.g., in, on, in contact with, integral with, or the like the solid fuel burning device). In some instances, only sensor(s) 14(1) and sensor(s) 14(N) may be part of the set up. In other instances, only sensors 14(1) and sensor(s) 14(M) may be part of the set up. In further instances, sensor(s) 14(1), sensor(s) 14(N), and sensor(s) 14(M) may be part of the set up. Additionally, while not shown sensor(s) can be positioned in a combination of examples 30 and 40 of FIGS. 3 and 4, with some sensor(s) 14(1)-14(N) grouped together in locations and other sensor(s) 14(1)-14(N) each positioned at separate locations, with or without local sensor(s) 14(M).

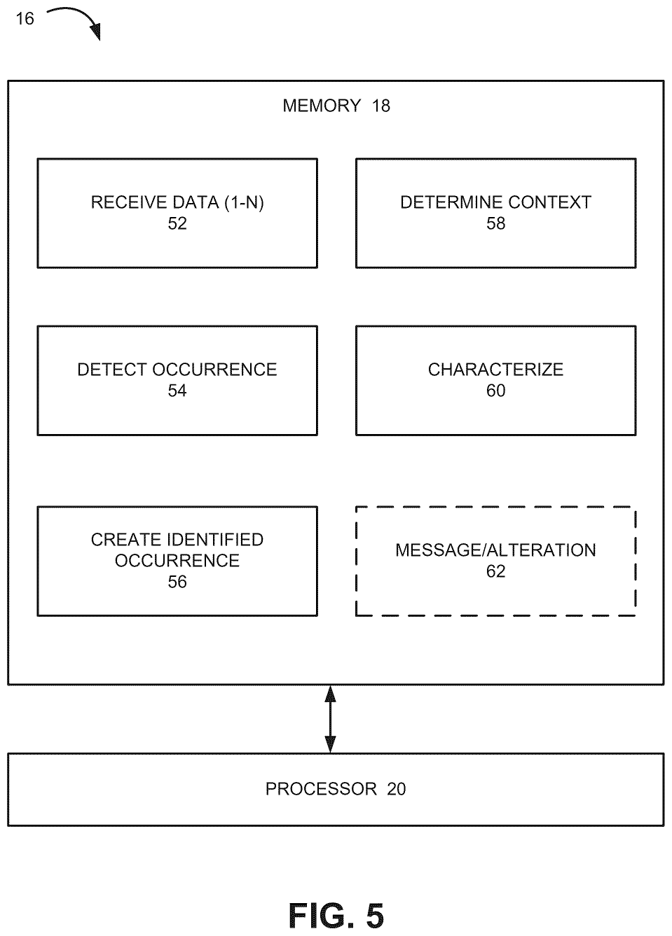

FIG. 5 shows an example of the controller 16 (e.g., and controller 116 by extension) in greater detail with regard to the memory 18 and processor 20. The controller(s) 16 can include instructions to receive 52 (and record) the data and the at least one other data (from the sensor(s) 14(1)-14(N)), and based on the data at a time and the at least one other data at the time detect 54 an occurrence related to an object associated with the solid fuel burning device in at least the data. The object associated with the solid fuel burning device 12 can be a component of the solid fuel burning device (e.g., door, fire box, flue, dampener, etc.), an element input into the solid fuel burning device (e.g., solid fuel), an element output of the solid fuel burning device (e.g., fire, smoke, etc.), an operator of the solid fuel burning device, or the like. The controller 16 can, for example, detect if the door is open, closed or a percent open/closed; detect an amount and/or type of fuel that has been loaded or reloaded at a given time; detect an overall amount and/or type of fuel that has been loaded since starting use; or the like. With temperature sensor the controller 16 can determine changes in temperature.

The controller(s) 16 can transform raw data from the sensor(s) into data that can be understood and interpreted into identified occurrences, such as matrices or another common data format. A key to transforming all raw data can be to extract out relevant data from a very complex raw data set and convert the data into a collection of new formats purpose built to understand and act upon the various states of the target device to create new states that are more optimal in terms of target performance characteristics.

The controller(s) 16 can create an identified occurrence 56 by selecting an identifier for the occurrence based on the data and/or the at least one other data. The identifier can be selected by proposing at least two possible identifiers for the occurrence based on the data (e.g., video data) or the at least one other data (e.g., temperature data, sound data, or the like) at the time, determining a confidence of each of the at least two optional identifiers for the occurrence based on the data (e.g., video data) and/or the other data (e.g., temperature data, sound data, or the like); and choosing one of the at least two possible identifiers with a higher confidence to be the identifier. The confidence of each of the at least two possible identifiers can be further confirmed by using a combination of the data and the other data and/or additional data from additional sensors of the same or different types.

For example, the door can be identified as open, closed, or a percent open. In another example, fuel input into an open door may be identified (e.g., if presented to a sensor, or verbal input) by amount, type, etc. The confidence in whether the door is open, closed, or partially open can be determined based on one or more data streams (e.g., video (does the door look open or closed, audio (was a sound made when the door closed), pressure (was a pressure wave sent when the door closed), temperature (is it hotter because the door is open), or the like). In another example, confidence in types and/or amounts of fuel that are input can be based on image data (e.g., visual indications), verbal indications (e.g., spoken by operator), or the like). The controller 16 can, when the sensor include temperature sensor(s), also and/or alternatively determine if a fire is burning too hot/too fast for optimal use, if temperature decreases below a threshold, if a possible malfunction has occurred, or the like).

Then the controller(s) 16 can determine a context 58 of the identified occurrence based on at least a stage of a fire cycle of the solid fuel burning device (e.g., determined based on the data and/or the other data). Examples of context for an open door (and possible fuel input) can include but are not limited to, initial fuel load, fuel reload, stoke without adding fuel, temporary increased air flow, moving fuel within firebox, or the like. Once the context is determined the controller(s) 16 can characterize 60 the identified occurrence in the context as satisfactory or sub-optimal. When the identified occurrence in the context is satisfactory, the system 10 can continue normal operation. When the identified occurrence in the context is sub-optimal, the system 10 can send a message 62 (e.g., output by the user interface 22) to a user of the solid fuel burning device and/or alter the solid fuel burning device 12. The message to the user can include at least one of: an instruction to fix the identified occurrence in the context that is sub-optimal, a suggestion for a next interaction with the solid fuel burning device, or a safety warning. The determination of what type of message to provide to user can be based on the identified occurrence in the context, instructions for operation of the solid fuel burning device, desired results, etc. For example, when fuel is loaded an open door can be satisfactory, if a door is open too long after the wood is loaded that can be unsatisfactory and a message can be, for example—instructions to close a door, suggestions for how to load fuel quicker, a warning that a door has been left partially open past a first limit, a call to a fire department if the door is open past another limit, or the like.

The controller(s) 16 can in some instances include a real-time training element that can learn and incorporate new instances of objects associated with the solid fuel burning device, the solid fuel burning device itself and/or the environment. For instance, type, model, and/or age of the solid fuel burning device, room settings, lighting conditions (e.g., over the course of a day/year, weather patterns, etc.), three dimensional angles and/or distances (e.g., between the solid fuel burning device and sensor(s)) that can vary (e.g., sensors can be moved (accidently and/or on purpose). The training element can recalibrate for new sensor positions and/or new objects unrelated to the solid fuel burning device in a sensor(s) path with and/or without user intervention.

Capabilities of the controller(s) 16 (some described in greater detail in other sections of this document) can include, but are not limited to: object classification, object identification, object detection, object landmark detection, object segmentation, object recognition, and heat map classification. Object classification: the controller 16 can determine if a target solid fuel burning device is within a data stream (e.g., video data) or if the sensor needs to be moved to see the target solid fuel burning device. Object identification: a make and model (and optionally age) of a solid fuel burning device can be identified within a data stream (e.g., video data, data input by user, etc.), the type of device (e.g., wood stove, fireplace, pellet stove, etc.), or the like. A rules engine for instructions can be at least partially personalized based on the type, make, and/or model to identify optimal actions for identified occurrences in context. Object Detection: the controller(s) 16 can determine where the solid fuel burning device and/or one or more components (e.g., door, door handle, bypass handle, air control rod, etc.) are within a data stream (e.g., video, audio, or the like), shapes of the device(s) and/or components, or the like and store this information in a memory 18. Object Detection: the controller 16 can determine one or more key points (and/or components) for the solid fuel burning device within a data stream (e.g., digital image). These one or more key points and/or components can be used to determine state changes—e.g., is the door position open or closed, is the bypass open or closed, has the air control lever position changed, length of time the door is open, angle of the open door/percent a door is open, or the like—and compare to previous states (e.g., before an interaction was detected, a time before the state change, or the like). Object segmentation: the controller can determine what part of the data stream belongs to a device (e.g., in an image what pixels). Thus, the controller 16 can determine if an object not associated with the solid fuel burning device (e.g., a chair, person, animal, is at least partially blocking view of the solid fuel burning device. The controller 16 can alert an operator to move the object not related to the solid fuel burning device is impeding the data collection (e.g., if is not removed after a chosen time) and/or can switch to an alternative sensor (of the same or different type) in a different position that is not determined to be obstructed). Object Recognition: the controller 16 can recognize a number of objects associated with the solid fuel burning device and location(s) the objects can be positioned. For example, is there a new load of wood in the wood box, the fire box, the operator's hands, the hearth, or the like; has a pile of wood changed in size, types of wood (oak, cherry, pine, etc.) based on bark, color, patterns, states of wood (wet/dry). Heat map classification: when at least one temperature sensor is utilized, then the controller can determine a heat profile of the solid fuel burning device, the surrounding environment, and/or individual components of the solid fuel burning device at different stages of the fire cycle and different contexts of use (e.g., high efficiency, high heat, banked burning, etc.).

### IV. Methods

Another aspect of the present disclosure can include methods 200, 300, 400, and 500 for monitoring, and improving use of, a solid fuel burning device. The methods 200, 300, 400, and 500 can be instructions stored on a non-transitory memory and executed by a hardware processor. For example, one or more elements of FIGS. 1-5 (e.g., system 10 including at least one controller 16 in combination with at least two sensors 14(1)-14(N)) can be used to implement the steps of methods 200, 300, 400, and 500. The methods can improve efficiencies, emissions, and operations of solid fuel burning devices by automatically extracting information about a solid fuel burning device and surrounding environment (one or more different types of information that might be state information) remotely, that is without touching the device, requiring modification or altering of the device, and without a user possessing any special expertise. As described herein the method (e.g., via system 10 or 110) can acquire, transform, process, analyze, and understand data sensed and collected from the sensors (which may include digital images, thermal images, and/or other types of data about the solid fuel burning device that may not be image data) and scans related to the solid fuel burning device and related environment, and can extract high-dimensional data from the real world to produce numerical or symbolic information, such as decisions, instructions, recommendations, and/or guidelines.

The methods 200, 300, 400, and 500 are illustrated as a process flow diagram with flow chart illustrations. For purposes of simplicity, the methods are shown and described as being executed serially; however, it is to be understood and appreciated that the present disclosure is not limited by the illustrated order, as some steps could occur in different orders and/or concurrently with other steps shown and described herein. Moreover, not all illustrated aspects may be required to implement the methods.

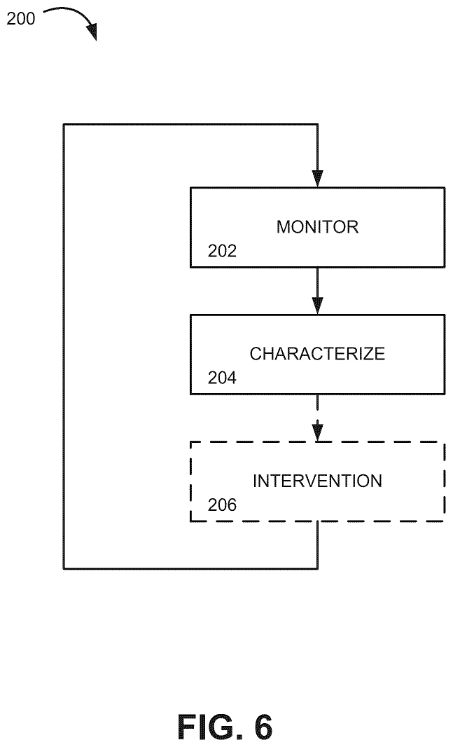

Referring now to FIG. 6, illustrated is a method 200 for continuous, real time monitoring of operation of a solid fuel burning device in order to provide intervention when necessary. The method 200 can be performed by any system (e.g., system 10, 100, etc.) that can include at least one remote (e.g., air-gapped) sensor (e.g., sensor(s) 14(1)), at least one other sensor (e.g., sensor(s) 14(N)), and a controller (e.g., controller 16) having at least a processor (e.g., processor 20) for storing and executing the instructions. The solid fuel burning device can be any solid fuel burning device (e.g., fireplace, woodstove, coal stove, etc.), new or legacy, and no modification and/or retrofitting of the solid fuel burning device is needed. Thus, regulations (e.g., EPA, international, etc.) for certifications can be maintained, setup of the system can be simple and self-performed (if desired), and the sensors (e.g., 14(1)-14(N)) can be cheaper, less heavy duty, and replaced significantly less often than if required to be positioned in the harsh environments inside or directly attached to or adjacent a solid fuel burning device.

At 202, the solid fuel burning device can be monitored by the at least one remote (e.g., air-gapped) sensor and at least one other sensor. The at least one other sensor can also be air-gapped from the solid fuel burning device (e.g., not touching any portion of the solid fuel burning device). However, in some instances the at least one other sensor can be an integral element of a solid fuel burning device (e.g., the system can be compatible with sensor(s) built into “newer” solid fuel burning devices), positioned near, inside, or adjacent a portion of the solid fuel burning device. In other instances, the at least one other sensor can be a portion of another system of the home (e.g., a thermostat, a security camera, a smoke detector, or the like) in communication with the processor (e.g., controller 16, processor 20). The monitoring can be performed by two more types of sensors that can respectively record two or more data streams associated with the operation of the solid fuel burning device. For example, two or more of video, light, temperature, sound, pressure, smoke, chemical, or the like. The rate of monitoring can be a set frequency (e.g., 1 second, 30 seconds, 1 minute, 5 minutes, 10 minutes, 30 minutes, 1 hour, etc.). In some instances, the sensors can have the same monitoring frequency and in other instances one or more of the sensors can have a different monitoring frequency from another. In some instances, a first sensor may trigger another sensor to activate (e.g., to save power, less invasive, etc.) when a condition of the data of the first sensor is met. For example, a video sensor may trigger an audio sensor to turn on when the door of the solid fuel burning device is opened to have a second data stream to confirm when the door is closed (both audio and visual) and after the door is confirmed closed, the audio sensor can return to a sleep or off mode.

The monitoring can be set (e.g., pre-set, calibrated, learned over time with machine learning, etc.) to detect occurrences related to object(s) associated with the solid fuel burning device. It should be understood that the occurrences and objects described herein are intended as illustrative and not intended to be limiting, thus any actions/interactions/of/in/on/related to the operation of the solid fuel burning device are considered.

At 204, the system can characterize an occurrence related to object(s) associated with the solid fuel burning device. Determinations of if a given occurrence (or grouping of occurrences) are satisfactory or sub-optimal can be made (e.g., by processor 20 of controller 16) based on the data from the at least two data streams (as discussed in more detail below). The characterization can include contextualizing the occurrences associated with the objects based on previously identified occurrences, the stage of the fire cycle, the desired result (e.g., pre-selected by the user—optimal efficiency, high heat, lowering fuel consumption, etc.), or the like. If the occurrence is determined to be satisfactory (e.g., within parameters for optimal or near optimal operation (e.g., 95% or more, 90% or more, 85% or more, 80% or more, 75% or more, 70% or more, 65% or more, 60% or more, or the like to optimal settings)), then no intervention is considered necessary and the next monitoring cycle can start. If the occurrence is determined to be sub-optimal (e.g., below parameters for optimal or near optimal operation for a given desired result of the solid fuel burning device), then, at 206, intervention (e.g., by the user, by the processor, by a component of the system, and/or the like) can be provided.

The intervention can include, but is not limited to, providing instructions to the user to fix an action (e.g., properly close a door, open a window or door in the room, add more wood, open the flue, or the like), suggestions for a next similar occurrence (e.g., don't keep the door open as long, don't use wet wood, use a different type of fuel (e.g., species of wood, type of coal, etc.) for optimal burn, allow more air when starting the fire, or the like), warnings (e.g., excess smoke detected, fire outside the solid fuel burning device, creosote buildup detected, unsafe operational practices, children/animals too close, etc.), automatic alterations to the solid fuel burning device (e.g., a connected solid fuel burning device) (e.g., open/close damper or flue, activate ventilation system, or the like). Then after the intervention, or if the intervention is ignored for a set time, the next monitoring cycle can begin. In some instances, in cases of extreme sub-optimal operation, such as occurrence of emergency conditions (e.g., external fire, harm to the operator, or the like), then emergency personnel can be notified (e.g., fire, police, ambulance, security company, etc.).

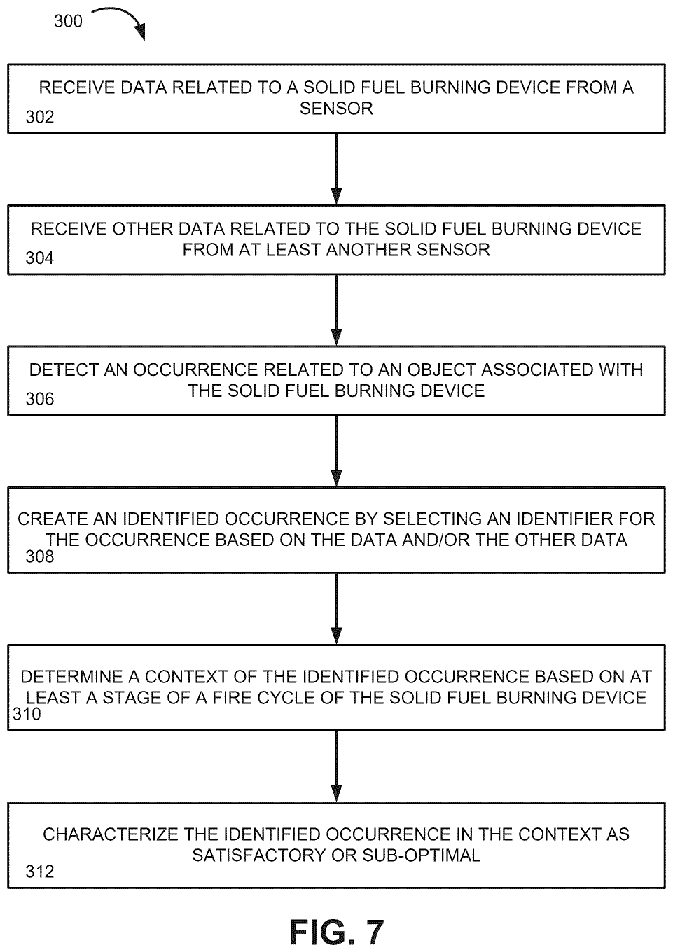

FIG. 7 shows a method 300 for monitoring and improving user operation of a solid fuel burning device (e.g., using the systems 10, 100). At 302, data related to solid fuel burning device can be received (by a system comprising at least a processor) from at least one sensor positioned remotely (e.g., air-gapped) from the solid fuel burning device. The at least one sensor can be at least one video sensor and the data can be video data that records at least a portion of the solid fuel burning device and/or an object associated with the solid fuel burning device). The data related to the solid fuel burning device can be recorded into a memory (e.g., local to the sensor, a non-transitory memory associated with the processor, on the cloud, and/or the like). At 304, other data related to the solid fuel burning device can be received from at least another sensor. The other sensor can include, for instance, a temperature sensor and the other data can be temperature data. At 306, an occurrence related to at least one object related to an object associated with the solid fuel burning device can be detected in at least the data (e.g., in the video data and, optionally, in the other data (such as temperature)). The other data related to the solid fuel burning device (e.g., temperature data or the like) can be recorded into a memory (e.g., local to the sensor, a non-transitory memory associated with the processor, on the cloud, and/or the like).

It should be understood that multiple occurrences related to multiple objects associated with the solid fuel burning device can occur simultaneously and/or in close proximity and can be individually detected and/or detected in a group. For example, opening the door, adding an amount of a type/species/class of solid fuel in one or more stages, and then closing the door can be individually detected and/or grouped as a single occurrence. The system can be calibrated before use for the specific solid fuel burning device (e.g., type, age, make, model, or the like), the environment (e.g., residential, commercial, cabin, light sources, obstructions, or the like), user preferences (e.g., designated operators, desired results, or the like), or the like. Calibration can also include placing and/or changing placement of sensor(s), determining average signal quality, teaching operators how to use the system, and/or the like. Additionally, while not shown, the data (e.g., video data or the like) and the at least the other data (e.g., temperature data, sound data, or the like) can be processed (e.g., filtered, run through algorithms, etc.) to remove environmental noise.

At 308, an identified occurrence can be created by selecting an identifier for the occurrence. The identifier can provide information about a state of the object and can be chosen from a group of possible identifiers associated with a given object. While identifier singular can be used an identifier can provide information about one or more aspects of an object and/or occurrence For example, a door can have an identifier of open, closed, or partially open. A solid fuel can have identifiers such as: the category (e.g., wood, coal, pellets, etc.), the type (e.g., for wood—pine, oak, maple, birch, cedar, etc.), state (e.g., wet, damp, dry, old, etc.), and/or amount (e.g., number of pieces, comparative amounts (small, medium, large), etc.). An animated object can be identified as a user or a non-user (e.g., a child, an animal, etc.) and as acting on the solid fuel burning device or another object related to the solid fuel burning device or merely passing by. Smoke can be identified by amount, chemical make-up, location (e.g., in chimney flue, in the room around the solid fuel burning device, etc.), or the like. At 310, a context of the identified occurrence can be determined based on at least a stage of a fire cycle of the solid fuel burning device. The context can also and/or alternatively be determined based on a desired result of the user, previously identified occurrences, or the like. At 312, the identified occurrence in the context can be characterized as satisfactory or sub-optimal. For instance, opening the door to add wood during decay may be satisfactory but not opening the door during the fully developed fire stage. When the identified occurrence in the context is characterized as satisfactory, then the system can continue with normal operation (e.g., start a new monitoring cycle). When the identified occurrence in the context is characterized as sub-optimal, then at least a message can be sent to a user of the solid fuel burning device. When a message is sent the system can continue monitoring, send follow up messages, or the like. In some instances, the system can autonomously intervene to correct a sub-optimal occurrence in context.

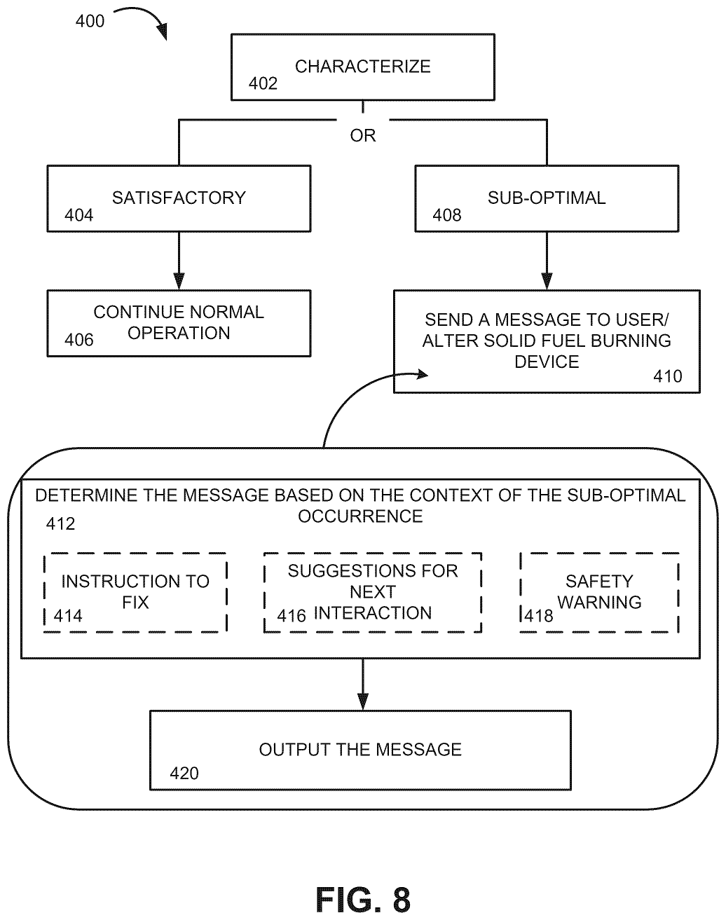

FIG. 8 shows a method 400 for characterizing an identified occurrence in context. At 402, the identified occurrence can be characterized as satisfactory or sub-optimal. The characterization can include determining if the identified occurrence is within pre-set parameters for the given context. If the identified occurrence is, at 404, satisfactory, then the system can, at 406, continue normal operation and a new monitoring cycle can begin (return arrow omitted for ease of illustration). If the identified occurrence is, at 408, sub-optimal in the context, then at 410, a message can be sent to the user and/or an alteration can be made to the solid fuel burning device. The message and/or alteration can be determined, at 412, based on the context of the sub-optimal occurrence, as well as the desired results and/or previously identified occurrences. The message can include, at 414, instructions to fix a faulty occurrence; at 416, suggestions for a next interaction with the solid fuel burning device to improve use; and/or, at 418, a safety warning (which can optionally include communication with emergency personnel is if warranted). At 420, the message can be output by a user interface. The message can be visual or audio and may include one or more haptics. The message can be (for example) a notification on a base station, a notification on a smart phone, tablet, TV, personal computer, or the like in communication with at least the processor.

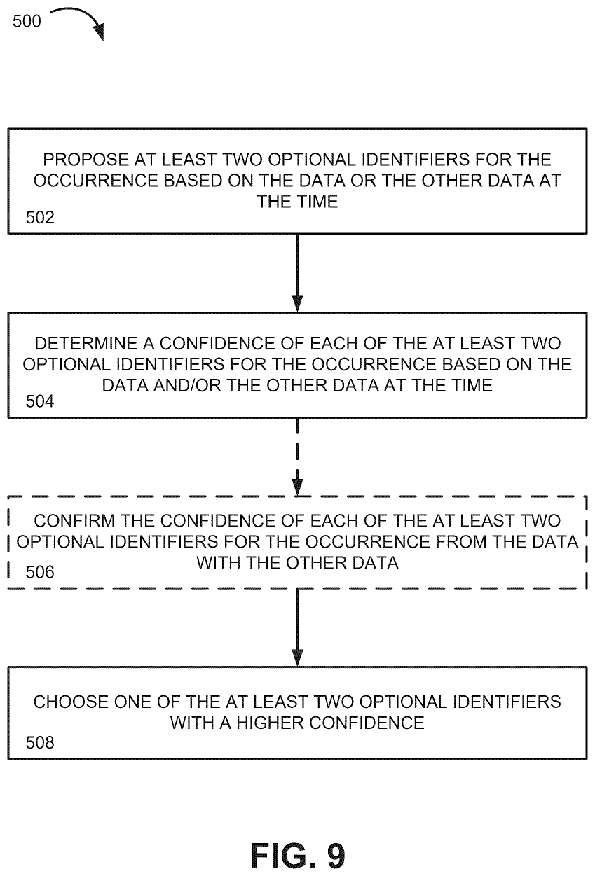

FIG. 9 shows a method 500 for selecting an identifier for an occurrence related to an object associated with a solid fuel burning device from a group of possible identifiers. The possible identifiers can be pre-set in memory, calibrated by the user, created by a machine learning algorithm (from single user and/or group data from a connected cloud environment), or the like. The possible identifiers can be simple (e.g., door open, closed, or partially open) or complex (e.g., two pieces of wet pine added to fire and door open for 1 minute). At 502, at least two optional identifiers for an occurrence can be proposed based on the data or the at least one other data (e.g., based on the video data or the temperature data) at a given time. At 504, a confidence can be determined for each of the at least optional identifiers for the occurrence based on the data, the other data, or a combination of the data and the other data. At 506, a confidence of each of possible identifiers can be further confirmed based on a combination of the data and the other data (and/or additional data from more data streams of additional sensor(s)). For instance, a confidence in the door being open, closed, or partially open can be based on both video and temperature data (e.g., video data shows door open or at least partially open) and temperature data can determine more confidently if the door is open or partially open (e.g., hotter if more open). At 508, the identifier can be selected by choosing the one of the at least two optional identifiers having the highest confidence.

In an example, not shown, where at least one of the sensor(s) is a video sensor, then the methods described above can include in more specific detail the following. At least image data can be acquired at a given frame rate of object(s) associated with the solid fuel burning device. Other data can be acquired at a same or different frequency from one or more other sensors (e.g., thermal images, audio files, or the like). The method can include transforming digital images of the object(s) associated with the solid fuel burning device at a point in time, setting (e.g., surrounding environment) information, and ancillary objects information near the device into descriptions and knowledge. The descriptions and knowledge can be created by determining state information from image data using models constructed with the aid of geometry, physics, statistics, and learning theory. Specifically, a digital image can be transformed into a series of specialized data sets that are mathematical representations of information in the image and can be used to determine if one or more elements in the image, corresponding to the abstract concept of an object (e.g., component, input element, output element, operator, or the like), changing in a material way (e.g., a change in an identifier of the object(s).

One way that an object change can be embodied can include three-dimension coordinates of key identifying points associated with the object (position of a door, handle, or level) changing from a reference location. For example, an identified matrices of three-dimensional coordinates corresponding to virtually tagged fixed positions on four corners of a door surface that now have different values can be compared to the reference location and/or one or more control positions (e.g., for open, specific percentages open, or the like). In other words, the image can be transformed into a complex set of values that represent the position of the door in three dimensions. When comparing a current position to control data, the system can determine from that transformed math model if a door is now in a different state, e.g., open versus closed. Other transformations of raw data residing in the digital image can be used to create additional models that can be used to determine if other abstract objects (e.g., handles, sliders, hinges, or the like more) have changed, and if so how, and what that does to affect a series of attributes or states of the solid fuel burning device. For instance, one solid fuel burning device can have an air bypass with a flip handle and another solid fuel burning device can have an air bypass with a slider handle and the system can be trained to know the different possible states (and accompanying meaning) for both types of handles.

Another example of image transformation can be described with respect to a heat map scan of the target device (e.g., one or more thermal sensors are part of the system). From this map, the data can be transformed into a series of mathematical models that represent heat data points applied to an area grid, bounded by a target border in some target portion of the map. The grid of data points can become a quick data set that can have one or more statistical models applied to it to render a singular value, that when combined with other time-based values can indicate a direction, magnitude, and/or speed of temperature change in the solid fuel burning device device. A key to transforming all raw data can be to extract out relevant data from a very complex raw data set and convert the data into a collection of new formats purpose built to understand and act upon the various states of the target device to create new states that are more optimal in terms of target performance characteristics.

The methods described herein can combine multiple types and sources of raw data, capturing and transforming data (e.g., captured via computer vision), such as video sequences, views from multiple cameras, multi-dimensional data from a 3D scanner, 3D point clouds from LiDaR sensors, and/or thermal scanning devices. It should be understood that specific methods can be used for combining, capturing, and/or transforming raw data from each type of sensor into usable data. Such transformations can include, but are not limited to object detection, event detection, activity recognition, object recognition, 3D pose estimation, learning, indexing, motion estimation, and 3D scene modeling. As a non-limiting example, a system can capture a raw digital representation (e.g., a digital image, a thermal image, or the like) of the target device and the surrounding environment. A digital image can contain information about the solid fuel burning device and its various components (in states that can be represented after processing as component states) and surrounding environment. The thermal scan can provide a thermal image of the same device, various components, and the surrounding environment and provide a device heat profile. Component state examples include but are not limited to [component=door; state=open, closed, or ajar (slightly open, with a reduced air flow profile)], [component=bypass handle; state=open, or closed], [component=airflow control lever, state=position 1, position 2, position 3, or position 4]. [component=airflow control dial, state varies from 0 -10 in 0.1 increments].

The raw captured data, images, and scans are then transformed into new images that simplify and enhance the captured data, images, and scans to enable further action from the system. Some examples of image transformation include: normalizing digital properties of the image, such as brightness or color, to enable consistent event detection; removing digital noise from an image, such as digital artifacts from low light levels when the device is used in a dark room or at night, and adjustment of the device data to correct for unique orientation within a room relative to the computer vision system, varying lighting conditions, and removal of interfering data from occlusion from other objects, and more.

From the above description, those skilled in the art will perceive improvements, changes, and modifications. Such improvements, changes and modifications are within the skill of one in the art and are intended to be covered by the appended claims.

The following is claimed:

1. A system that monitors operation of a solid fuel burning device, the system comprising:
at least one video sensor located remote from the solid fuel burning device configured to record video data that monitors actions and behavior related to the solid fuel burning device;
at least another sensor configured to record at least temperature data related to the solid fuel burning device;
at least one controller comprising:
a non-transitory memory storing instructions; and
a processor configured to execute the instructions to:
receive the video data and the temperature data:
detect an occurrence related to an object associated with the solid fuel burning device in at least the video data;
create an identified occurrence by selecting an identifier for the occurrence based on the video data and/or the temperature data;
determine a context of the identified occurrence based on at least a stage of a fire cycle of the solid fuel burning device; and
characterize the identified occurrence in the context as satisfactory or sub-optimal, such that:
when the identified occurrence in the context is satisfactory, continue normal operation; and
when the identified occurrence in the context is sub-optimal, send a message to a user of the solid fuel burning device.

2. The system of claim 1, wherein the identifier is selected by:
proposing at least two optional identifiers for the occurrence based on the video data or the temperature data at the time, wherein the identifier is one of the at least two optional identifiers;
determining a confidence of each of the at least two optional identifiers for the occurrence based on the video data and/or the temperature data; and
choosing one of the at least two optional identifiers with a higher confidence.

3. The system of claim 2, wherein the temperature data from the at least the other sensor is used to confirm the confidence in the video data from the sensor.

4. The system of claim 1, when the identified occurrence in the context is sub-optimal, the processor further executes instructions to:
determine the message to provide to the user of the solid fuel burning device based on the context of the sub-optimal identified occurrence; and
output the message to the user.

5. The system of claim 1, further comprising a user interface configured to present the message to the user, wherein the user interface comprises at least one of an audio interface, a visual interface, or a haptic interface.

6. The system of claim 1, wherein the message to the user comprises at least one of: an instruction to fix the identified occurrence in the context that is sub-optimal, a suggestion for a next interaction with the solid fuel burning device, or a safety warning.

7. The system of claim 1, wherein the object associated with the solid fuel burning device is a component of the solid fuel burning device, an element input into the solid fuel burning device, or an element output of the solid fuel burning device.

8. The system of claim 1, wherein the controller further comprises a wireless transmitter configured to connect the controller with a cloud-based server.

9. The system of claim 1, wherein the at least one other sensor further comprises at least one of: a light capture sensor, a temperature sensor, an audio sensor, a pressure sensor, or a chemical sensor.

10. The system of claim 1, wherein the sensor and the at least the other sensor are different types of sensors.

11. The system of claim 1, wherein the sensor and the at least the other sensor are positioned at same or different remote locations.

12. The system of claim 1, wherein the at least one video sensor is remote and not physically touching any part of the solid fuel burning device.

13. A method comprising
receiving, by a system comprising a processor, video data related to a solid fuel burning device from a sensor located remotely from the solid fuel burning device;
receiving, by the system, another data type comprising at least temperature data related to the solid fuel burning device from at least another sensor;
detecting, by the system, an occurrence related to an object associated with the solid fuel burning device in at least the video data;
creating, by the system, an identified occurrence by selecting an identifier for the occurrence based on the video data and/or the temperature data;
determining, by the system, a context of the identified occurrence based on at least a stage of a fire cycle of the solid fuel burning device; and
characterizing, by the system, the identified occurrence in the context as satisfactory or sub-optimal, such that:
when the identified occurrence in the context is satisfactory, continue normal operation; and
when the identified occurrence in the context is sub-optimal, send a message to a user of the solid fuel burning device.

14. The method of claim 13, wherein the identifier is selected by:
proposing at least two optional identifiers for the occurrence based on the video data or the temperature data at the time, wherein the identifier is one of the at least two optional identifiers;
determining a confidence of each of the at least two optional identifiers for the occurrence based on the video data and/or the temperature data; and
choosing one of the at least two optional identifiers with a higher confidence.

15. The method of claim 14, further comprising confirming, by the system, the confidence of each of the at least two optional identifiers for the occurrence from the video data with the temperature data.

16. The method of claim 13, when the identified occurrence in the context is sub-optimal, the method further comprising:
determining, by the system the message to provide to the user of the solid fuel burning device based on the context of the sub-optimal identified occurrence; and
outputting, by a user interface of the system, the message to the user.

17. The method of claim 13, wherein the message to the user comprises at least one of: an instruction to fix the sub-optimal occurrence, a suggestion for a next interaction with the solid fuel burning device, or a safety warning.

18. The method of claim 11, further comprising:
recording, by the sensor, the data related to the solid fuel burning device; and
recording, by the at least the other sensor, the temperature data related to the solid fuel burning device.

19. The method of claim 13, further comprising processing, by the system, the video data and the other data to remove environmental noise.

20. The method of claim 13, further comprising calibrating, by the system, the system for a specific solid fuel burning device and environment.
